(19) United States
(12) Patent Application Publication
(10) Pub. No.: US 2012/0256955 A1
(43) Pub. Date: Oct. 11, 2012

(54) SYSTEM AND METHOD FOR ENABLING AUGMENTED REALITY IN REPORTS

(75) Inventors: Atul Narendra Gupta, Pune (IN); Chandan Mahadeo Gokhale, Norcross (IN)

(73) Assignee: INFOSYS LIMITED, Bangalore (IN)

(21) Appl. No.: 13/424,948

(22) Filed: Mar. 20, 2012

(30) Foreign Application Priority Data
Apr. 7, 2011 (IN) 1184/CHE/2011

(51) Int. Cl. G09G 5/00

(52) U.S. Cl. 345/633

(57) ABSTRACT

In accordance with various embodiments of the present invention, the electronic device checks whether a viewing application capable of rendering augmented reality (AR) is present in the electronic device. If such a viewing application is present, the viewing application identifies any augmented reality (AR) markers present in the physical document. On identifying an AR marker in the document, the viewing application (or the electronic device) fetches relevant content from a predefined source and displays the relevant content to the user. The relevant content may be any of a chart, a 3D chart, a report, a video recording, and so forth. In case the viewing application is not already present, the electronic device downloads the viewing application from a predefined location.

### CROSS REFERENCE TO RELATED APPLICATIONS

This application claims priority to Indian Patent Application No. 1184/CHE/2011, filed Apr. 7, 2011, which is hereby incorporated by reference in its entirety.

### TECHNICAL FIELD

The present invention relates to the field of augmented reality (AR) in general. In particular, the present invention provides a system and method for enabling AR in reports.

### BACKGROUND

Augmented reality (AR) is a term for a live direct or an indirect view of a physical, real-world environment whose elements are augmented by computer-generated sensory input such as sound, video, graphics or GPS data. It is related to a more general concept called mediated reality, in which a view of reality is modified by a computer. As a result, the technology functions by enhancing one's current perception of reality. By contrast, virtual reality replaces the real world with a simulated one. Augmentation is conventionally in real-time and in semantic context with environmental elements, such as sports scores on TV during a match. With the help of advanced AR technology (e.g. adding computer vision and object recognition) the information about the surrounding real world of the user becomes interactive and digitally manipulable. Artificial information about the environment and its objects can be overlaid on the real world.

Reports and Brochures are today typically available as printed hard copies or as PDF/Word document softcopies. These are usually non-interactive. Augmented reality is an upcoming technology and mostly is being used in advertising. It hasn't been put to lot of business use as yet. Printed reports can only carry so much information and aren't interactive. Many times need someone to explain additional aspects in person or readers need to do additional lookup themselves.

Hence there is a requirement in the art to make the reports and brochures more interactive and provide readers with more immersive experience using augmented reality. It also takes off on the wide acceptance of smart phones today and brings additional information right on these devices for the users.

### SUMMARY OF THE INVENTION

Aspects of the disclosure relate to an electronic device checking whether a viewing application capable of rendering augmented reality (AR) is present in the electronic device. If such a viewing application is present, the viewing application identifies any augmented reality (AR) markers present in the physical document. On identifying an AR marker in the document, the viewing application (or the electronic device) fetches relevant content from a predefined source and displays the relevant content to the user. The relevant content may be any of a chart, a 3D chart, a report, a video recording, and so forth. In case the viewing application is not already present, the electronic device downloads the viewing application from a predefined location.

In another embodiment of the present disclosure, the electronic device may be any device having a camera such as, for example, a mobile phone, a laptop, a desktop computer, a tablet PC, and the like. As used herein, the suitable viewing application is any application that is capable of rendering AR on the electronic device being used. In case such a suitable viewing application is not installed in the electronic device, the electronic device downloads the application from a predefined location. For example, as discussed earlier, such a predefined location may be specified in the physical document in the form of an HTTP link. Once the viewing application is installed on the electronic device, the viewing application identifies the marker, fetches the relevant content from a predefined source, such as a remote database, and displays the relevant content to the user.

### DRAWINGS

Features, aspects, and advantages of the present invention will be better understood when the following detailed description is read with reference to the accompanying drawings in which like characters represent like parts throughout the drawings, wherein:

FIG. 1 shows an environment in which the present invention can be practiced in accordance with an embodiment of the present invention;

FIG. 2 is a flow chart depicting a method for enabling augmented reality in reports, in accordance with an embodiment of the present invention; and

FIG. 3 is a system illustrating a generalized computer network arrangement, in one embodiment of the present technique.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

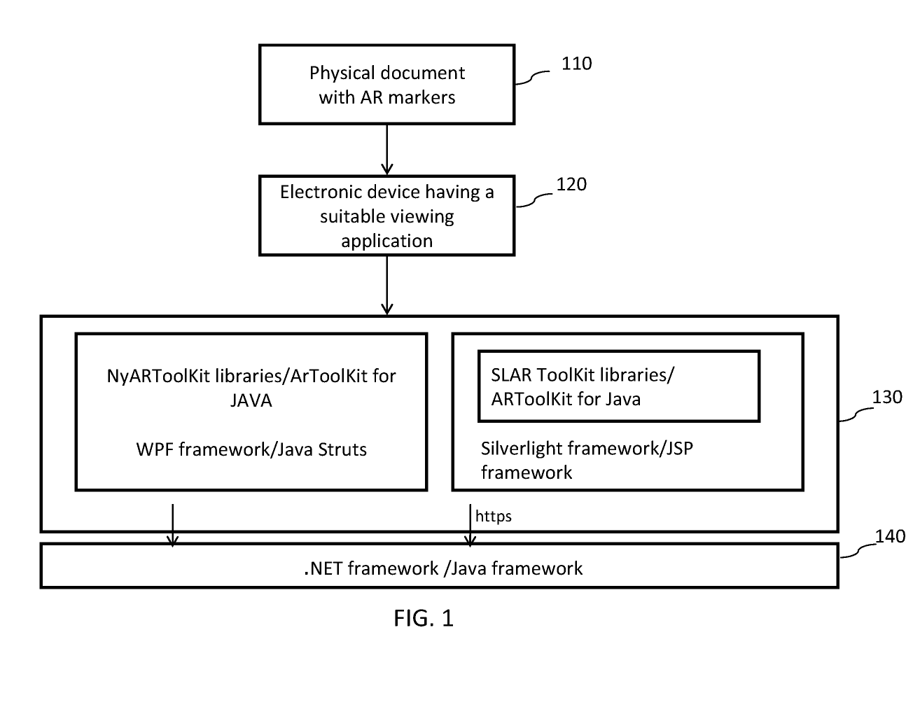

FIG. 1 shows an environment in which the present invention can be practiced, in accordance with an embodiment of the present invention. FIG. 1 includes a physical document having one or more markers, an electronic device and an underlying framework.

In accordance with various embodiments of the present invention, the electronic device checks whether a viewing application capable of rendering augmented reality (AR) is present in the electronic device (120). If such a viewing application is present, the viewing application identifies any augmented reality (AR) markers present in the physical document (110). On identifying an AR marker in the document, the viewing application (or the electronic device) fetches relevant content from a predefined source and displays the relevant content to the user. The relevant content may be any of a chart, a 3D chart, a report, a video recording, and so forth. In case the viewing application is not already present, the electronic device downloads the viewing application from a predefined location.

In accordance with various embodiments of the present invention, the physical document may be any of a report, a sales brochure, and so forth. As described earlier, the physical document may have one or more imprinted markers. The physical document may also contain an HTTP link to a location from where a suitable viewing application may be downloaded by a user to view the additional information, in case the suitable viewing application is not already installed in the electronic device. Further, the physical document may be any of a PDF document, a Microsoft Word document, a Microsoft PowerPoint presentation, and the like.

The electronic device may be any device having a camera such as, for example, a mobile phone, a laptop, a desktop computer, a tablet PC, and the like. As used herein, the suitable viewing application is any application that is capable of rendering AR on the electronic device being used. In case such a suitable viewing application is not installed in the electronic device, the electronic device downloads the application from a predefined location. For example, as discussed earlier, such a predefined location may be specified in the physical document in the form of an HTTP link. Once the viewing application is installed on the electronic device, the viewing application identifies the marker, fetches the relevant content from a predefined source, such as a remote database, and displays the relevant content to the user. The relevant content may be any information such as a chart, a 3D chart, a marketing report, a video recording, and the like. In accordance with an embodiment of the present invention, information on what content should be fetched by the viewing application from the remote database is embedded in the viewing application itself. Further, the user may rotate the marker around to get different views of such charts and videos.

As shown in FIG. 1, the underlying framework may be a .NET framework (130,140), a Java framework, and so forth. It should be understood that these are merely illustrative examples of frameworks that may be used and are non-restrictive. Further, based on the framework used, appropriate libraries supported by that framework may be used to implement the described invention.

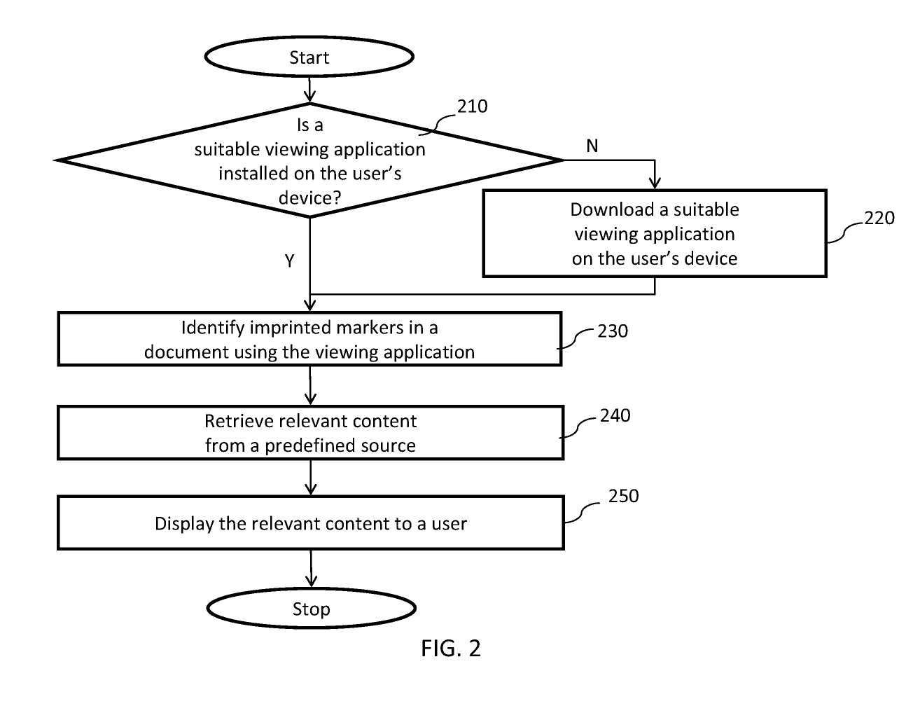

FIG. 2 is a flow chart depicting a method for enabling augmented reality in reports, in accordance with an embodiment of the present invention. An electronic device, such as a mobile phone, a laptop, a tablet PC, and the like checks whether a viewing application capable of rendering augmented reality is installed in the electronic device (210). If the viewing application is already installed, the viewing application identifies an imprinted marker (if any) on a physical document, such as a PDF document, a Microsoft Word document, and the like (230). The viewing application then fetches relevant content from a predefined source, such as a remote database, and displays the content to the user (240). In accordance with an embodiment of the present invention, information on what content should be fetched by the viewing application from the remote database is embedded in the viewing application itself. However, if a suitable viewing application is not installed in the electronic device, the electronic device downloads the application from a predefined location that may be specified in the physical document (220). The relevant content may be a chart, a 3D chart, a video recording, a report, and so forth (250).

Thus, the present invention makes the otherwise static reports and brochures interactive, and helps in providing a more immersive experience to users. The users can access additional information easily, thereby having a better understanding of the information provided in the reports.

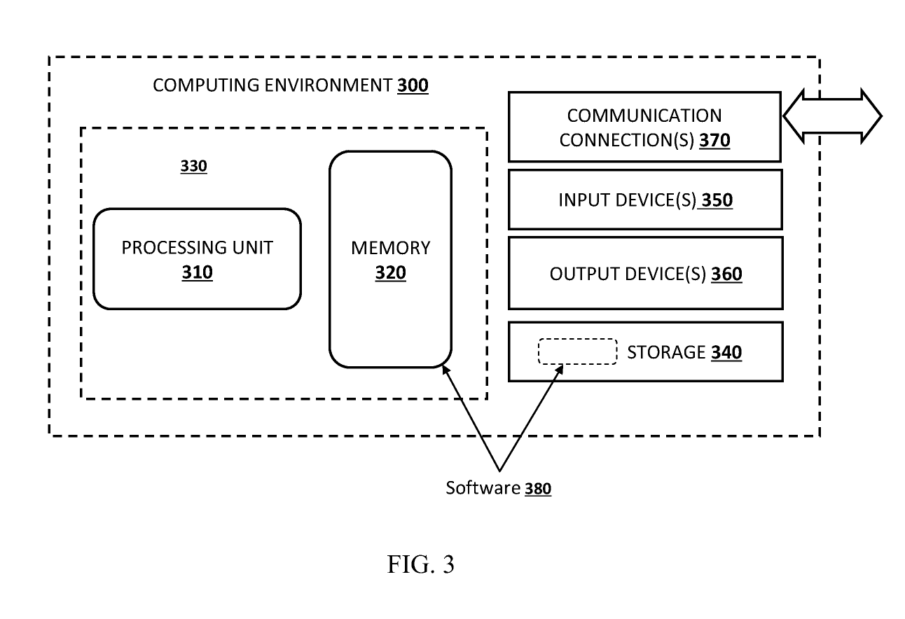

One or more of the above-described techniques may be implemented in or involve one or more computer systems. FIG. 3 illustrates a generalized example of a computing environment 300. The computing environment 300 is not intended to suggest any limitation as to scope of use or functionality of described embodiments.

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 implementing described techniques.

A computing environment may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which may be used to store information and which may be accessed within the computing environment 300. In some embodiments, the storage 340 stores instructions for the software 380.

The input device(s) 350 may be a touch input device such as a keyboard, mouse, pen, trackball, touch screen, or game controller, a voice input device, a scanning device, a digital camera, or another device that provides input to the computing environment 300. The output device(s) 360 may be a display, printer, speaker, or another device that provides output from the computing environment 300.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 300, computer-readable media include memory 320, storage 340, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

In view of the many possible embodiments to which the principles of our invention may be applied, we claim as our invention all such embodiments as may come within the scope and spirit of the following claims and equivalents thereto.

What is claimed is:

1. A method for enabling augmented reality in a report, the method comprising:
determining whether a viewing application is present in at least one electronic device, wherein the viewing application is capable of rendering augmented reality;
identifying at least one augmented reality marker present in a document;
fetching content from a pre-defined source by the viewing application; and
displaying a relevant content to a user.

2. The method of claim 1, wherein fetching content from a pre-defined source by the viewing application further comprises:
fetching content from a pre-defined source by the at least one electronic device.

3. The method of claim 1, wherein the at least one electronic device is one or more of:
a camera;
a mobile phone;
a laptop;
a desktop computer; and
a handheld computer.

4. The method of claim 1, wherein the relevant content is one or more of:
a chart;
a three dimensional chart;
a report; and
a video recording.

5. The method of claim 1, further comprises:
downloading the viewing application from the pre-defined location.

6. A system for enabling augmented reality in a report, the system comprising:
a first electronic device configured to check the presence of viewing application installed in a second electronic device;
the viewing application configured to identify an imprinted marker on a physical document; and
an output device communicably coupled to the viewing application, the output device configured to display a relevant content to a user.

7. The system of claim 6, wherein the physical document is one or more of:
a power-point presentation;
a PDF document; and
a microsoft word document.

8. The system of claim 6, wherein the first electronic device is one or more of:
a camera;
a mobile phone;
a laptop;
a desktop computer; and
a handheld computer.

9. The system of claim 6, wherein the second electronic device is one or more of:
a camera;
a mobile phone;
a laptop;
a desktop computer; and
a handheld computer.

10. The system of claim 6, wherein the relevant content is one or more of:
a chart;
a three dimensional chart;
a report; and
a video recording.

11. The system of claim 6, wherein the viewing application is further configured to:
fetch the relevant content from a database.

12. A computer program product, comprising a machine-accessible medium having instructions encoded thereon for enabling a processor to perform the operations of:
program code adapted for determining whether a viewing application is present in at least one electronic device, wherein the viewing application is capable of rendering augmented reality;
program code adapted for identifying at least one augmented reality marker present in a document;
program code adapted for fetching content from a pre-defined source by the viewing application; and
program code adapted for displaying a relevant content to a user.

13. The computer program product of claim 12, further comprising program code adapted for fetching content from a pre-defined source by the at least one electronic device.

14. The computer program product of claim 12, further comprising program code adapted for downloading the viewing application from the pre-defined location.
